(19) United States
(12) Patent Application Publication
(10) Pub. No.: US 2020/0293311 A1
(43) Pub. Date: Sep. 17, 2020

(54) FORMAT CONVERTER FOR INTERACTIVE MEDIA

(71) Applicant: AppOnboard, Inc., Los Angeles, CA (US)

(72) Inventors: Adam Piechowicz, Los Angeles, CA (US); Jonathan Zweig, Santa Monica, CA (US); Bryan Buskas, Sherman Oaks, CA (US); Abraham Pralle, Seattle, WA (US); Sloan Tash, Long Beach, CA (US); Armen Karamian, Los Angeles, CA (US); Rebecca Mauzy, Los Angeles, CA (US)

(21) Appl. No.: 16/684,095

(22) Filed: Nov. 14, 2019

Related U.S. Application Data
(60) Provisional application No. 62/819,494, filed on Mar. 15, 2019.

(51) Int. Cl. G06F 8/76

(52) U.S. Cl. CPC G06F 8/76

(57) ABSTRACT

A method may include obtaining a script, the script including a first scene associated with a first asset, a second scene associated with a second asset, a first action, and a first transition from the first scene to the second scene. The method may include generating an asset list based on the first asset and the second asset and generating a first state corresponding with the first scene and the first action and a second state corresponding with the second scene. The method may include verifying the first action and the first transition from the first scene to the second scene and generating a first view associated with the first state and a first triggering event. The method may include re-verifying the first action and the first transition and combining the asset list, the first state, the second state, and the first view to generate an interactive media item.

### CROSS REFERENCE TO RELATED APPLICATION

A claim for benefit of priority to the Mar. 15, 2019 filing date of the U.S. Patent Provisional Application No. 62/819,494, titled STUDIO BUILDER FOR INTERACTIVE MEDIA (the '494 Provisional Application), is hereby made pursuant to 35 U.S.C. § 119(e). The entire disclosure of the '494 Provisional Application is hereby incorporated herein.

### TECHNICAL FIELD

Embodiments of the present disclosure relate to the field of converting formats of interactive media.

### BACKGROUND

An application or interactive media item may be written in any of a number of programming languages. However, some hardware components and/or devices may only be able to play back interactive media items that are written in particular languages and/or may be optimized for playback of interactive media items in particular languages. An interactive media item that is written in one programming language may run well on one device (e.g. a particular model of cellular telephone) but may be unable to run and/or may run poorly on another device (e.g., a different model of cellular telephone).

### SUMMARY

A method may include obtaining a script, the script including a first scene associated with a first asset, a second scene associated with a second asset, a first action, and a first transition from the first scene to the second scene. The method may include generating an asset list based on the first asset and the second asset and generating a first state corresponding with the first scene and the first action and a second state corresponding with the second scene. The method may include verifying the first action and the first transition from the first scene to the second scene and generating a first view associated with the first state and a first triggering event. The method may include re-verifying the first action and the first transition and combining the asset list, the first state, the second state, and the first view to generate an interactive media item.

### BRIEF DESCRIPTION OF THE DRAWINGS

Example embodiments will be described and explained with additional specificity and details through the use of the accompanying drawings in which:

FIG. 1 illustrates an example environment to convert the format of an interactive media item;

FIG. 2 is a flowchart of an example computer-implemented method to convert the format of an interactive media item; and

FIG. 3 illustrates an example computing device that may be used to convert the format of an interactive media item.

### DETAILED DESCRIPTION

The following disclosure sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely examples. Particular implementations may vary from these example details and still be contemplated to be within the scope of the present disclosure.

An application or interactive media item may be written in any of a number of programming languages. However, some hardware components and/or devices may only be able to play back interactive media items that are written in particular languages and/or may be optimized for playback of interactive media items in particular languages. Thus, an interactive media item that is written in one programming language may run well on one device (e.g. a particular model of cellular telephone) but may be unable to run and/or may run poorly on another device (e.g., a different model of cellular telephone). To address this the incompatibility and to address other problems, the interactive media item may be written in any programming language and may then converted to another such as, for example, HyperText Markup Language (HTML) 5. Additionally or alternatively, some digital application stores, such as those provided by Apple, Google, and Microsoft, and/or some operating systems or hardware may place limitations on a format for download of applications. For example, applications may need to be in an HTML5 format for some operating systems and/or environments and may need to be in a JavaScript format for other operating systems and/or environments.

Embodiments of the present disclosure may provide technology that can help users to convert an interactive media item from one format to another format without the user having knowledge of coding. For example, a user may select an interactive media item, select a desired output format for the interactive media item, and convert the interactive media item from a first format to the desired output format without knowing any programming language. The techniques and tools described herein may create the required source code to convert the interactive media item from a first format to a second format based on selections made by the user and without the user typing even one line of code.

Various embodiments of the present disclosure may improve the functioning of computer systems by, for example, creating applications that run on more hardware systems and/or run better on particular hardware systems by converting an application from one programming language to another programming language. Additionally, the conversion of an application may result in a reduced size of the converted application that may be stored in an online marketplace. Conversion of an application and/or reducing the size of an application may result in fewer computing resources required to store and download applications or other interactive media items. Additionally, some embodiments of the present disclosure may facilitate conversion of interactive media items by computer programming novices, who may not be required to learn programming languages in order to convert an interactive media item from one format to a second format.

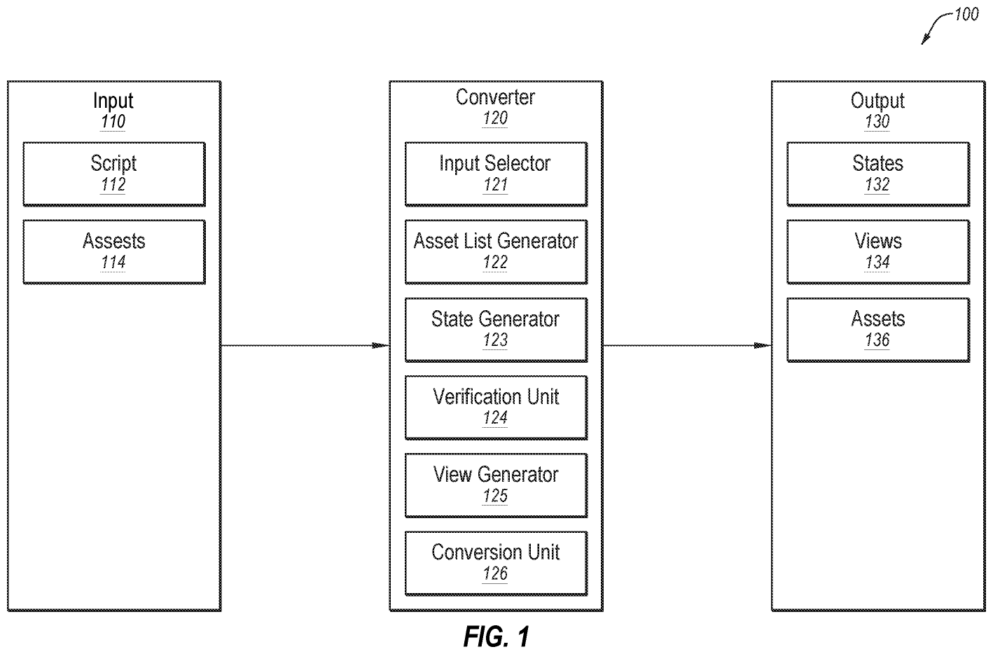

FIG. 1 illustrates an example system 100 in which embodiments of the present disclosure can be implemented. The system 100 includes an input 110, a converter 120, and an output 130.

The input 110 may include an interactive media item, such as a game, a program, an application, and an application demonstration (“app demo”). In some embodiments, the interactive media item may include or be related to a demonstration of a game, an application, or another feature for a mobile device or another electronic device. In some embodiments, the interactive media item may include various video segments that are spliced together to generate interactive media for demonstrating portions of a game, use of an application, or another feature of a mobile device or an electronic device. As another example, the interactive media item may include a training video that permits a user to simulate training exercises. The interactive media item may include any number and any type of media assets that are combined into the interactive media item.

The input 110 may include a script 112 and one or more assets 114. For example, in some embodiments, the script 112 may include a JavaScript Object Notation (JSON) script. The script 112 may include instructions and/or computer programming which may direct the performance of the input 110. A processor may execute instructions included in the script 112 to perform one or more operations. For example, the operations in the script 112 may include the execution of a game, an application, or another interactive media item. In some embodiments, the script 112 may include or be divided into one or more scenes. For example, a scene may be a distinct portion of a software program that may be associated with particular assets of the one or more assets 114, particular actions, particular transitions, etc. In some embodiments, the script 112 may include one or more programming instructions. For example, the script 112 may include instructions that, when executed by a processor, cause the processor to play back one or more assets 114.

The assets 114 may include video assets, audio assets, and/or image assets. For example, the assets 114 may include multiple videos that may be played at different times based on instructions included in the script 112. For example, during execution of an interactive media item, instructions in the script 112 may cause a first video to be presented during a first scene. In response to receiving input such as, for example, a gesture, instructions in the script 112 may cause the interactive media item to proceed to a second scene in which a second video may be presented.

The converter 120 may include a computing device such as a personal computer (PC), a laptop, a mobile phone, a smart phone, a tablet computer, a netbook computer, an e-reader, a personal digital assistant (PDA), or a cellular phone etc. In some embodiments, the converter 120 may include memory and one or more processors configured to convert the input 110 to the output 130. For example, the input 110 may be an interactive media item in a first format and the converter 120 may convert the interactive media item from the first format to the second format, which may include the output 130. In some embodiments, the converter 120 may include an input selector 121, an asset list generator 122, a state generator 123, a verification unit 124, and a view generator 125.

The output 130 may include an interactive media item, such as a game, a program, an application, and an app demo. In some embodiments, the output 130 may represent the same interactive media item as the input 110. For example, the output 130 may be the same interactive media item as the input 110 in a different format. The output 130 may include one or more states 132, one or more views 134 and one or more assets 136. In some embodiments, the one or more assets 136 of the output 130 may correspond with and/or be the same as the one or more assets 114 of the input 110. In some embodiments, the one or more states 132 may correspond with scenes of the script 112. In some embodiments, the one or more views 134 may be associated with a state of the one or more states 132 and a triggering event. The triggering event may include any event or action which may cause a change in a state of the one or more states 132 during the execution of a program. For example, in some embodiments, the triggering event may include an input element to receive input from a user. For example, an input element may include a touch element. Touch elements may include a region on a screen and a corresponding gesture. For example, the touch element may be a swipe at a particular location or in a particular direction.

During operation of the system 100, the input selector 121 of the converter 120 may select as an input 110 an interactive media item. In some embodiments, the input selector 121 may receive input from a user such as, for example, text input selecting a particular file as the input 110 and/or a mouse click identifying a particular file as the input 110. The interactive media item may be in a first format. For example, the interactive media item may be in a JSON format. The input selector 121 may select the interactive media item in the JSON format as the input 110. The input 110 may include a script 112 and one or more assets 114. The script 112 may include one or more scenes. Each scene may be associated with an asset of the one or more assets 114, an action, and/or a transition. For example, a scene may include one or more actions that may occur upon entering the scene. These actions may occur when entering the scene from a different scene. Alternatively or additionally, a scene may include one or more actions that may occur upon exiting the scene. These actions may occur when exiting the scene to a different scene. Alternatively or additionally, in some embodiments, the action may include an action that occurs at a particular time after entering the scene. In some embodiments, actions may include playing an audio file or a video file, presenting an image, starting a timer, setting a variable to a value, etc. In some embodiments, a transition may include a movement from one scene to another scene. For example, a first scene may transition to a second scene and the second scene may transition to a third scene or back to the first scene.

The asset list generator 122 of the converter 120 may generate an asset list 136 from the assets 114 of the input 110.

The state generator 123 of the converter 120 may generate one or more states 132 corresponding to the scenes in the script 112. For example, in some embodiments, the state generator 123 may generate one state 132 for each scene in the script 112. The state generator 123 may generate the states 132 based on the scenes, actions, and transitions in the script 112.

The verification unit 124 of the converter 120 may then verify the actions and the transitions between the states. For example, the converter 120 may verify that a first state 132 correctly transitions to a second state 132.

The view generator 125 of the converter 120 may also generate one or more views 134. In some embodiments, each view 134 may be associated with a state and one or more triggering events such as, for example, touch elements. For example, the input elements may include an interface input such as a mouse click, optical input such as an eye blink, and/or a touch element such as gestures on a touch screen, among other input formats. For example, a touch element may be a position on a display of a device on which a user may interact with the display through the use of one or more gestures. For example, a touch element may include an area and a type of a gesture. For example, the area may be any shape and the type of gesture may include a tap, a swipe, a double tap, etc. In some embodiments, the views 134 may be associated with elements of the list of elements 136. For example, a view may be associated with or may include a first asset and a first triggering event. The first triggering event may be associated with at least a portion of the first asset such as, for example, a particular area of the first asset. The first triggering event may also be a touch element and may be associated with a type of gesture such as tap, a slide, a double tap, etc. The first triggering event may also be associated with a transition. For example, the first triggering event may be associated with a transition from a first scene to a second scene such that, in response to receiving input in the form of mouse click, an optical input, and/or a particular gesture in the particular area, the interactive media item, when executed, may transition from the first scene to the second scene.

The verification unit 124 may then re-verify the actions and the transitions between the states. The conversion unit 126 of the converter 120 may then combine the asset list 136, the states 132, and the views 134 to generate an interactive media item. For example, the converter 120 may combine the asset list 136, the states 132, and the views 134 to generate an interactive media item in an HTML5 format. In some embodiments, the converter 120 may encode the asset list, the states, and the views to generate a single playable unit. For example, the converter 120 may combine the asset list 136, the states 132, and the views 134 into a single file to generate the output 130. In some embodiments, the converter 120 may obfuscate the asset list 136, the states 132, and the views 134 and may generate the output 130 based on the obfuscated asset list 136, the obfuscated states 132, and the obfuscated views 134. In some embodiments, the converter 120 may encode the asset list 136 using Base64 encoding. In these and other embodiments, the converter 120 may generate the output 130 by combining the encoded asset list 136, the states 132, and the views 134. In some embodiments, the script 112 may be in a JSON format and the states 132, the views 134, and the asset list 136 may be in a JavaScript (JS) format. For example, the states 132, the views 134, and the asset list 136 may be separate objects.

In practice, the input 110 may include many scenes and the output 130 may correspondingly include many states 132. A scene may include transitions to multiple different other scenes and each transition may be associated with a different triggering event. For example, a first transition from the first scene to a second scene may be associated with a triggering event. A second transition from the first scene to a third scene may be associated with a second triggering event.

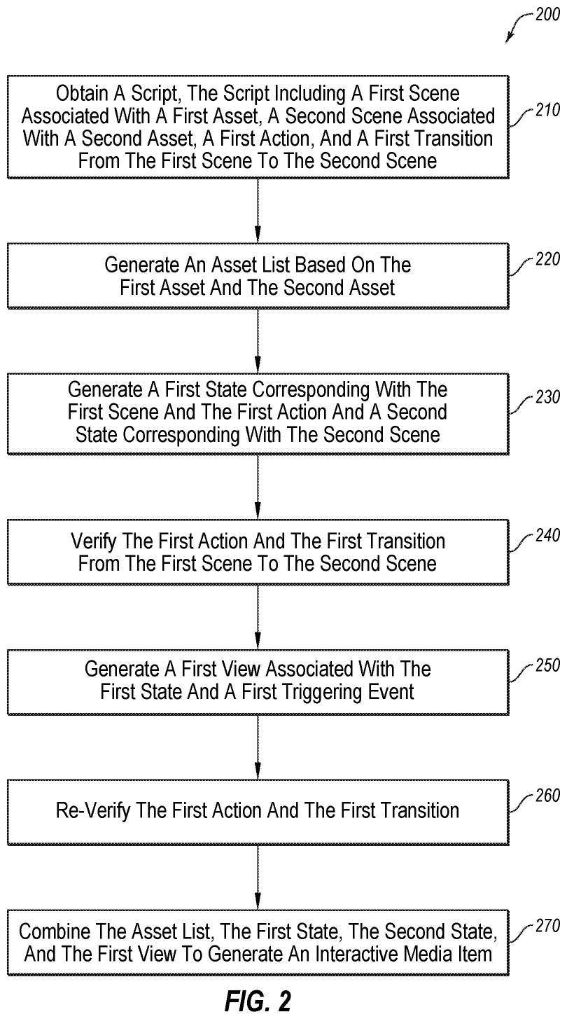

FIG. 2 is a flow diagram illustrating methods for performing various operations, in accordance with some embodiments of the present disclosure, including performing editing functions of media data. The methods may be performed by processing logic that comprises hardware (e.g., circuitry, dedicated logic, programmable logic, microcode, etc.), software (e.g., instructions run on a processor to perform hardware simulation), or a combination thereof. Processing logic can control or interact with one or more devices, applications or user interfaces, or a combination thereof, to perform operations described herein. When presenting, receiving or requesting information from a user, processing logic can cause the one or more devices, applications or user interfaces to present information to the user and to receive information from the user.

For simplicity of explanation, the method of FIG. 2 is illustrated and described as a series of operations. However, acts in accordance with this disclosure can occur in various orders and/or concurrently and with other operations not presented and described herein. Furthermore, not all illustrated operations may be required to implement the methods in accordance with the disclosed subject matter. In addition, those skilled in the art will understand and appreciate that the methods could alternatively be represented as a series of interrelated states via a state diagram or events.

FIG. 2 is a flow diagram illustrating a method 200 for converting an interactive media item. At block 210, processing logic may obtain a script. The script may include a first scene associated with a first asset, a second scene associated with a second asset, a first action, and a first transition from the first scene to the second scene. At block 220, the processing logic may generate an asset list based on the first asset and the second asset. At block 230, the processing logic may generate a first state corresponding with the first scene and the first action and a second state corresponding with the second scene.

At block 240, the processing logic may verify the first action and the first transition from the first scene to the second scene. At block 250, the processing logic may generate a first view associated with the first state and a first triggering event. At block 260, the processing logic may re-verify the first action and the first transition. At block 270, the processing logic may combine the asset list, the first state, the second state, and the first view to generate an interactive media item.

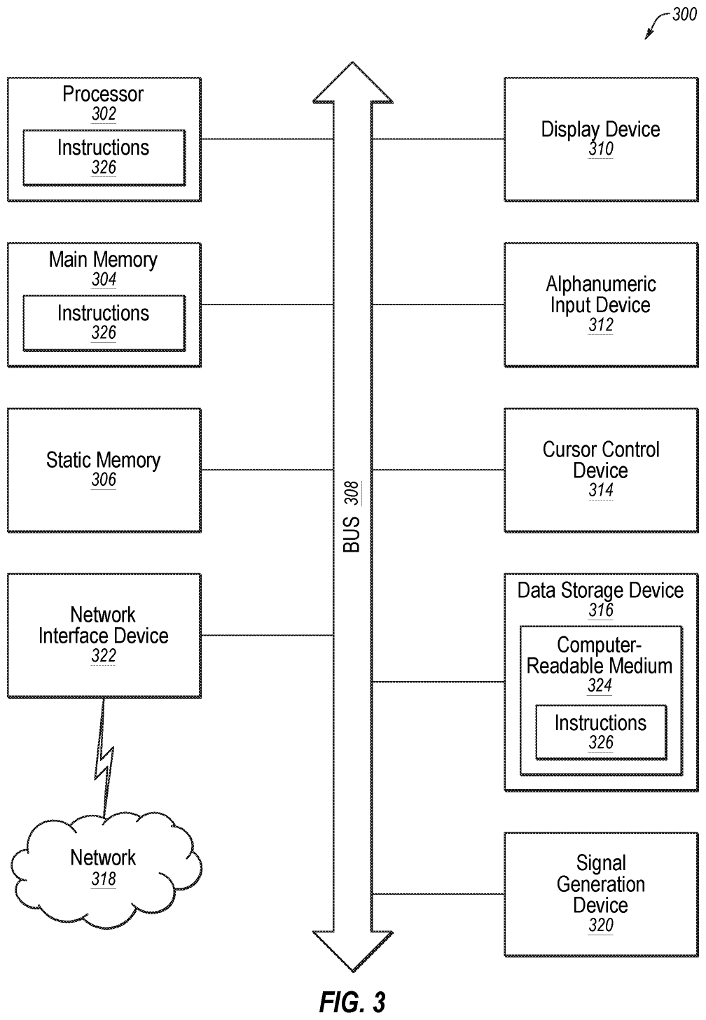

FIG. 3 illustrates a diagrammatic representation of a machine in the example form of a computing device 300 within which a set of instructions, for causing the machine to perform any one or more of the methodologies discussed herein, may be executed. The computing device 300 may be a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computing device 300 includes a processing device (e.g., a processor) 302, a main memory 304 (e.g., read-only memory (ROM), flash memory, dynamic random access memory (DRAM) such as synchronous DRAM (SDRAM)), a static memory 306 (e.g., flash memory, static random access memory (SRAM)) and a data storage device 316, which communicate with each other via a bus 308.

Processing device 302 represents one or more processing devices such as a microprocessor, central processing unit, or the like. More particularly, the processing device 302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 302 may also be one or more special-purpose processing devices such as an application specific integrated circuit (ASIC), a field programmable gate array (FPGA), a digital signal processor (DSP), network processor, or the like. The processing device 302 is configured to execute instructions 326 for performing the operations and steps discussed herein.

The computing device 300 may further include a network interface device 322 which may communicate with a network 318. The computing device 300 also may include a display device 310 (e.g., a liquid crystal display (LCD) or a cathode ray tube (CRT)), an alphanumeric input device 312 (e.g., a keyboard), a cursor control device 314 (e.g., a mouse) and a signal generation device 320 (e.g., a speaker). In one implementation, the display device 310, the alphanumeric input device 312, and the cursor control device 314 may be combined into a single component or device (e.g., an LCD touch screen).

The data storage device 316 may include a computer-readable storage medium 324 on which is stored one or more sets of instructions 326 embodying any one or more of the methodologies or functions described herein. The instructions 326 may also reside, completely or at least partially, within the main memory 304 and/or within the processing device 302 during execution thereof by the computing device 300, the main memory 304 and the processing device 302 also constituting computer-readable media. The instructions may further be transmitted or received over a network 318 via the network interface device 322.

While the computer-readable storage medium 324 is shown in an example embodiment to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media and magnetic media.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying,” “subscribing,” “providing,” “determining,” “unsubscribing,” “receiving,” “generating,” “changing,” “requesting,” “creating,” “uploading,” “adding,” “presenting,” “removing,” “preventing,” “playing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a computer selectively activated or reconfigured by a computer program stored in the computer. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

The algorithms and displays presented herein are not inherently related to any particular computer or other apparatus. Various systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

The above description sets forth numerous specific details such as examples of specific systems, components, methods and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth above are merely examples. Particular implementations may vary from these example details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
obtaining a script, the script including a first scene associated with a first asset, a second scene associated with a second asset, a first action, and a first transition from the first scene to the second scene;
generating an asset list based on the first asset and the second asset;
generating a first state corresponding to the first scene and the first action and a second state corresponding with the second scene;
verifying the first action and the first transition from the first scene to the second scene;
generating a first view associated with the first state and a first triggering event; and
combining the asset list, the first state, the second state, and the first view to generate an interactive media item.

2. The method of claim 1 further comprising encoding the asset list using Base64 encoding, wherein combining the asset list, the first state, the second state, and the first view to generate the interactive media item comprises combining the encoded asset list, the first state, the second state, and the first view to generate the interactive media item.

3. The method of claim 1, wherein the first view includes the first asset and the first triggering event and wherein the first triggering event is a touch element and is associated with at least a portion of the first asset, a type of gesture, and the first transition.

4. The method of claim 3, further comprising re-verifying the first action and the first transition, wherein the script further includes a third scene associated with a third asset and a second transition from the first scene to the third scene, further comprising:
generating a third state corresponding with the third scene;
verifying the second transition from the first scene to the third scene;
generating a second view associated with the first scene and a second triggering event, the second triggering event being different from the first triggering event; and
re-verifying the second transition,
wherein generating the asset list is further based on the third asset and wherein combining the asset list, the first state, the second state, and the first view to generate the interactive media item comprises combining the asset list, the first state, the second state, the third state, the first view, and the second view to generate the interactive media item.

5. The method of claim 1, further comprising obfuscating the asset list, the first state, the second state, and the first view and wherein combining the asset list, the first state, the second state, and the first view to generate the interactive media item comprises combining the obfuscated asset list, the obfuscated first state, the obfuscated second state, and the obfuscated first view to generate the interactive media item.

6. The method of claim 1 wherein combining the asset list, the first state, the second state, and the first view to generate the interactive media item comprises placing the asset list, the first state, the second state, and the first view in a single file to generate the interactive media item.

7. The method of claim 1 wherein the first action includes an action on entering the first state, an action on exiting the first state, or an action at a particular time after entering the first state.

8. A system comprising:
a memory; and
a processing device coupled with the memory, the processing device being configured to:
obtain a script, the script including a first scene associated with a first asset, a second scene associated with a second asset, a first action, and a first transition from the first scene to the second scene;
generate an asset list based on the first asset and the second asset;
generate a first state corresponding with the first scene and the first action and a second state corresponding with the second scene;
verify the first action and the first transition from the first scene to the second scene;
generate a first view associated with the first state and a first triggering event;
re-verify the first action and the first transition; and
combine the asset list, the first state, the second state, and the first view to generate an interactive media item.

9. The system of claim 8, the processing device being further configured to encode the asset list using Base64 encoding, wherein combining the asset list, the first state, the second state, and the first view to generate the interactive media item comprises combining the encoded asset list, the first state, the second state, and the first view to generate the interactive media item.

10. The system of claim 8 wherein the first view includes the first asset and the first triggering event and wherein the first triggering event is a touch element and is associated with at least a portion of the first asset, a type of gesture, and the first transition.

11. The system of claim 10 wherein the script further includes a third scene associated with a third asset and a second transition from the first scene to the third scene and the processing device being further configured to:
generate a third state corresponding with the third scene;
verify the second transition from the first scene to the third scene;
generate a second view associated with the first scene and a second triggering event, the second triggering event being different from the first triggering event; and
re-verify the second transition,
wherein generating the asset list is further based on the third asset and wherein combining the asset list, the first state, the second state, and the first view to generate the interactive media item comprises combining the asset list, the first state, the second state, the third state, the first view, and the second view to generate the interactive media item.

12. The system of claim 8, the processing device being further configured to obfuscate the asset list, the first state, the second state, and the first view and wherein combining the asset list, the first state, the second state, and the first view to generate the interactive media item comprises combining the obfuscated asset list, the obfuscated first state, the obfuscated second state, and the obfuscated first view to generate the interactive media item.

13. The system of claim 8 wherein combining the asset list, the first state, the second state, and the first view to generate the interactive media item comprises placing the asset list, the first state, the second state, and the first view in a single file to generate the interactive media item.

14. The system of claim 8 wherein the first action includes an action on entering the first state, an action on exiting the first state, or an action at a particular time after entering the first state.

15. A non-transitory computer readable storage medium having instructions stored therein which, when executed, cause a processing device to perform operations comprising:
obtaining a script, the script including a first scene associated with a first asset, a second scene associated with a second asset, a first action, and a first transition from the first scene to the second scene;
generating an asset list based on the first asset and the second asset;
generating a first state corresponding with the first scene and the first action and a second state corresponding with the second scene;
verifying the first action and the first transition from the first scene to the second scene;
generating a first view associated with the first state and a first triggering event;
re-verifying the first action and the first transition; and
combining the asset list, the first state, the second state, and the first view to generate an interactive media item.

16. The non-transitory computer readable storage medium of claim 15, the operations further comprising encoding the asset list using Base64 encoding, wherein combining the asset list, the first state, the second state, and the first view to generate the interactive media item comprises combining the encoded asset list, the first state, the second state, and the first view to generate the interactive media item.

17. The non-transitory computer readable storage medium of claim 15 wherein the first view includes the first asset and the first triggering event and wherein the first triggering event is a touch element and is associated with at least a portion of the first asset, a type of gesture, and the first transition.

18. The non-transitory computer readable storage medium of claim 17 wherein the script further includes a third scene associated with a third asset and a second transition from the first scene to the third scene and the operations further comprise:
generating a third state corresponding with the third scene;
verifying the second transition from the first scene to the third scene;
generating a second view associated with the first scene and a second triggering event, the second triggering event being different from the first triggering event; and
re-verifying the second transition,
wherein generating the asset list is further based on the third asset and wherein combining the asset list, the first state, the second state, and the first view to generate the interactive media item comprises combining the asset list, the first state, the second state, the third state, the first view, and the second view to generate the interactive media item.

19. The non-transitory computer readable storage medium of claim 15, the operations further comprising obfuscating the asset list, the first state, the second state, and the first view and wherein combining the asset list, the first state, the second state, and the first view to generate the interactive media item comprises combining the obfuscated asset list, the obfuscated first state, the obfuscated second state, and the obfuscated first view to generate the interactive media item.

20. The non-transitory computer readable storage medium of claim 15 wherein combining the asset list, the first state, the second state, and the first view to generate the interactive media item comprises placing the asset list, the first state, the second state, and the first view in a single file to generate the interactive media item.
